(19) United States
(12) Patent Application Publication
(10) Pub. No.: US 2025/0329508 A1
(43) Pub. Date: Oct. 23, 2025

(54) LOAD BREAK TOOL WITH RESET INDICATOR

(71) Applicant: Hubbell Incorporated, Shelton, CT (US)

(72) Inventors: Jacob Worthington Blake, Birmingham, AL (US); Evan Jacob Hunter, Foristell, MO (US)

(21) Appl. No.: 19/186,033

(22) Filed: Apr. 22, 2025

Related U.S. Application Data
(60) Provisional application No. 63/637,073, filed on Apr. 22, 2024.

(51) Int. Cl. H01H 31/00

(52) U.S. Cl. CPC H01H 31/006

(57) ABSTRACT

A load break tool includes a main body extending along a longitudinal axis between a first end and a second end. The main body is movable between an extended configuration and a retracted configuration. The main body includes an indicator housing having a window. A trigger assembly is positioned in the main body. The trigger assembly is moveable between a first position in the retracted configuration and a second position in the extended configuration. The trigger assembly includes an indicator viewable by a user through the window when the main body is in the retracted position.

### RELATED APPLICATION(S)

This application is based on U.S. Provisional Application Ser. No. 63/637,073, filed Apr. 22, 2024, the disclosure of which is incorporated herein by reference in its entirety and to which priority is claimed.

### FIELD

Various exemplary embodiments relate to a load break tool for opening a high-voltage electrical system under load.

### BACKGROUND

Load break tools are used to open disconnects, cutouts, power fuses, fuse limiters, and other electrical switches under load. Load break tools prevent an external arc between the contacts of the switch when the switch is disconnected. External arcs can be carried to nearby components and cause electrical shorting or other damage to the components. In extreme cases, external arcs can cause fires. Load break tools extinguish an arc by drawing the arc through a thin, confined spaced of air, limiting the potential for damage before the arc disperses.

### SUMMARY

In certain configurations, a load break tool includes an indicator viewable by a user. In certain configurations the indicator indicates to a user that a reset operation of the tool has been completed.

In certain configurations, a load break tool includes a main body extending along a longitudinal axis between a first end and a second end. The main body being movable between an extended configuration and a retracted configuration. The main body including an indicator housing having a window. A trigger assembly positioned in the main body, the trigger assembly moveable between a first position in the retracted configuration and a second position in the extended configuration. The trigger assembly including an indicator viewable by a user through the window when the main body is in the retracted position.

In certain configurations, a load break tool includes a main body extending along a longitudinal axis between a first end and a second end. The main body being movable between an extended configuration and a retracted configuration. The main body including an indicator housing having a window. A trigger assembly positioned in the main body, the trigger assembly moveable between a first position in the retracted configuration and a second position in the extended configuration. The trigger assembly including an indicator viewable by a user through the window when the main body is in the retracted position. A first contact coupled to the first end and configured to selectively couple with a first switch contact. A second contact coupled to the second end and configured to selectively couple with a second switch contact, wherein in the retracted configuration the first contact is in electrical communication with the second contact. A spring assembly mounted in the main body for biasing the main body to the retracted configuration, the spring assembly including a compression spring.

In certain configurations, a load break tool includes an outer tube extending along a longitudinal axis and defining a first cavity. The outer tube includes an outer tube end cap. An indicator housing extends from the outer tube, the indicator housing including a window. An inner tube at least partially received inside the first cavity and defining a second cavity. The inner tube being movable with respect to the outer tube along the longitudinal axis between a retracted position and an extended position. A trigger assembly is connected to the inner tube. The trigger assembly includes an indicator viewable by a user through the window when the inner tube is in the retracted position. A guide rod is fixed to the outer tube and extending into the second cavity, the guide rod including a first surface. A spring tube is coaxially mounted around the guide rod and selectively axially coupled to the inner tube by the trigger assembly, the spring tube including a second surface. A compression spring is mounted between the first surface and the second surface. When the spring tube is coupled to the inner tube by the trigger assembly, the compression spring biases the inner tube toward the retracted position.

### BRIEF DESCRIPTION OF THE DRAWINGS

The aspects and features of various exemplary embodiments will be more apparent from the description of those exemplary embodiments taken with reference to the accompanying drawings.

FIG. 1 is a perspective view of a load break tool.

FIG. 2 is a cross-sectional view of the load break tool of FIG. 1 in a closed or retracted position.

FIG. 2A is a close-up view of a first end of the tool of FIG. 2.

FIG. 2B is a close-up view of a middle of the tool of FIG. 2.

FIG. 2C is a close-up view of a second end of the tool of FIG. 2.

FIG. 3 is a cross-sectional view of the load break tool of FIG. 1 in a trip position.

FIG. 4 is a cross-sectional view of the load break tool of FIG. 1 in an open position.

FIG. 5 is a perspective view of another load break tool.

FIG. 6 is a close-up view of a first end of the tool of FIG. 5.

FIG. 7 is an exploded view of the indicator housing of FIG. 5.

FIG. 8 is a side view of the indicator housing of FIG. 5.

FIG. 9 is a perspective view of a portion of the inner tube and the trigger assembly.

FIG. 10 is a perspective view of a portion of the trigger assembly.

FIG. 11 is a partial, side perspective view of the load break tool of FIG. 5 in the extended or open position and the indicator not visible in the window.

FIG. 12 is a partial, side perspective view of the load break tool of FIG. 5 in the retracted or closed position and the indicator visible in the window.

### DETAILED DESCRIPTION OF EXEMPLARY EMBODIMENTS

Load break tools are portable devices that can be positioned by a lineman to safely open utility line switches under load, such as disconnects, cutouts, power fuses, and fuse limiters. The lineman can attach the load break tool to the end of a hot stick so that switches can be opened from a safe distance. The use of the load break tool helps prevent any arcing when opening the switch. An example of a load break tool is shown and described in U.S. patent application Ser. No. 18/094,009, which is incorporated by reference herein in its entirety.

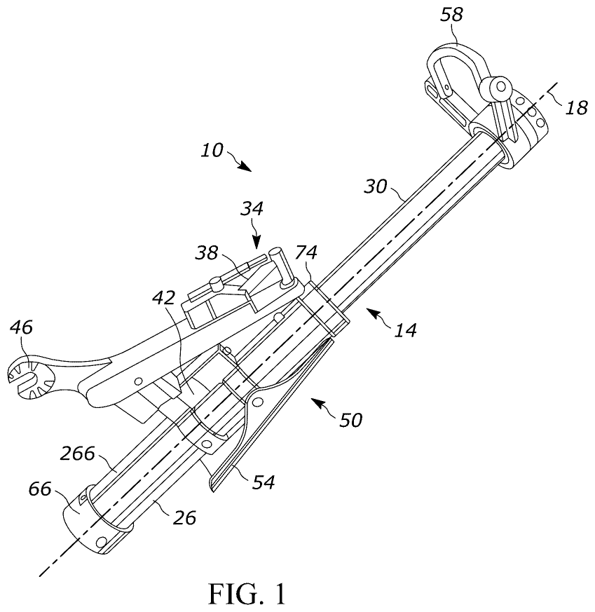

FIG. 1 illustrates an exemplary load break tool 10. The load break tool 10 includes a main body 14 or a tube assembly extending along a tool axis 18. In the illustrated configuration, portions of the load break tool 10 are referred to using directional terms such as upper and lower, or top and bottom. These terms are refer to the frame of reference shown in FIG. 1. The use of such directional terms is not meant to limit the orientation of the load break tool.

In certain configurations, the main body 14 includes an outer tube 26 formed as a cylindrical pipe extending along the tool axis 18. An inner tube 30, similarly formed as a cylindrical pipe, is slidably received in an upper end of the outer tube 26. The main body 14 is movable between an extended configuration, in which the inner tube 30 extends from the upper end of the outer tube 26, and a retracted configuration, in which the inner tube 30 is mostly received within the outer tube 26.

The load break tool 10 can further includes a clip assembly 34. In the illustrated configuration, the clip assembly 34 is spring biased and includes a gate 38 biased into a closed position. The gate 38 selectively allows a component, such as a switch contact, to be engaged by the clip assembly 34. The clip assembly 34 is mounted on a bracket 42 that can also supports a universal adapter 46. The bracket 42 is mounted to the outer tube 26.

The universal adapter 46 couples the load break tool 10 with an insulated pole, such as a hot stick, or any other structure used by an operator to maneuver the load break tool 10. The universal adapter 46 transfers forces from the insulated pole to the clip assembly 34 and the outer tube 26. A release clamp assembly 50 is mounted to the outer tube 26 opposite the clip assembly 34. In certain configurations, the release clamp assembly 50 is mounted to the outer tube 26 using the same bracket 42. In other configurations, the release clamp assembly 50 cab be separately mounted. The release clamp assembly 50 includes a release paddle 54 mounted to the outer tube 26 for movement between a locked position and a release position. The load break tool 10 further includes a hook loop 58 coupled to the upper end of the inner tube 30. The hook loop 58 is configured to engage a second contact of the switch.

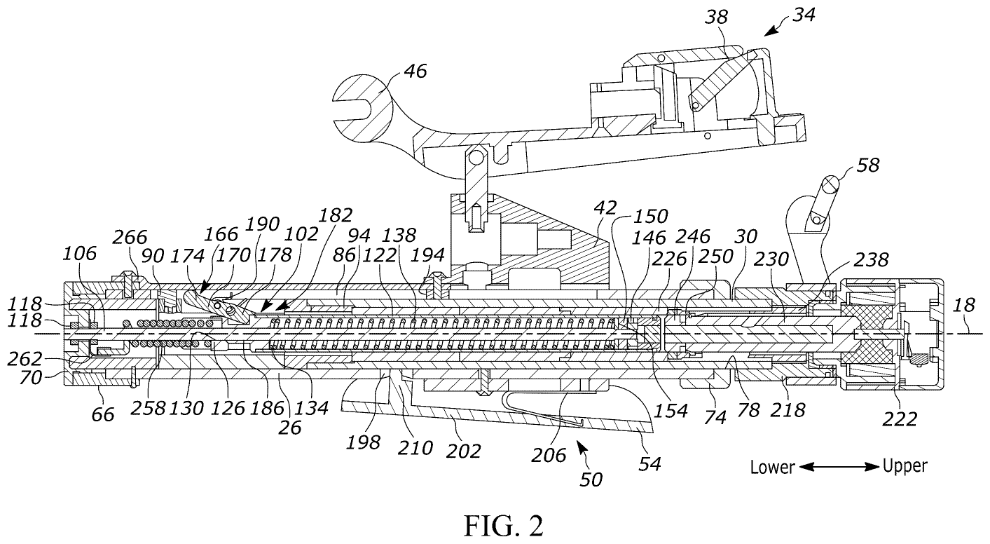

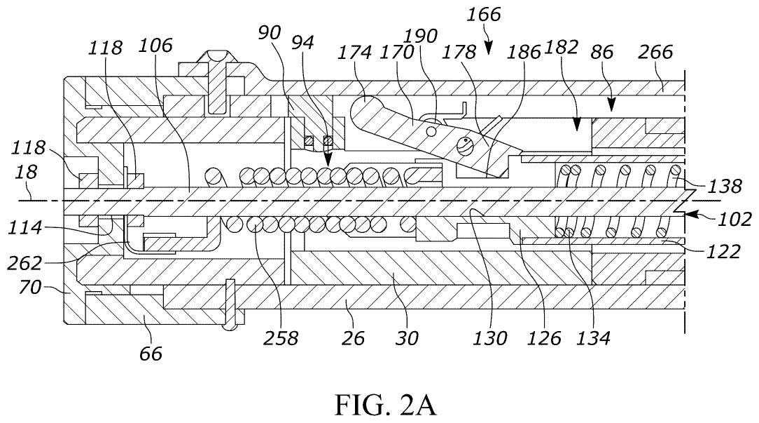

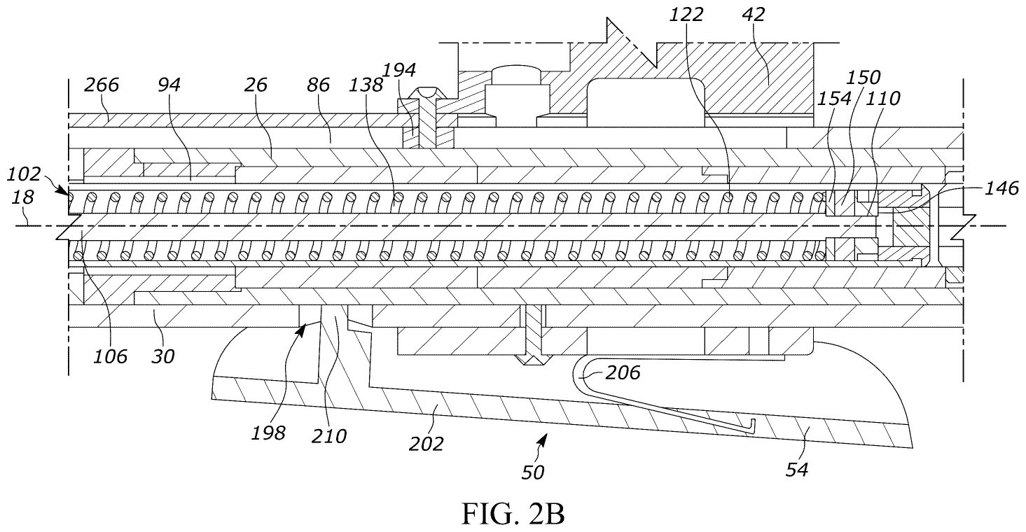

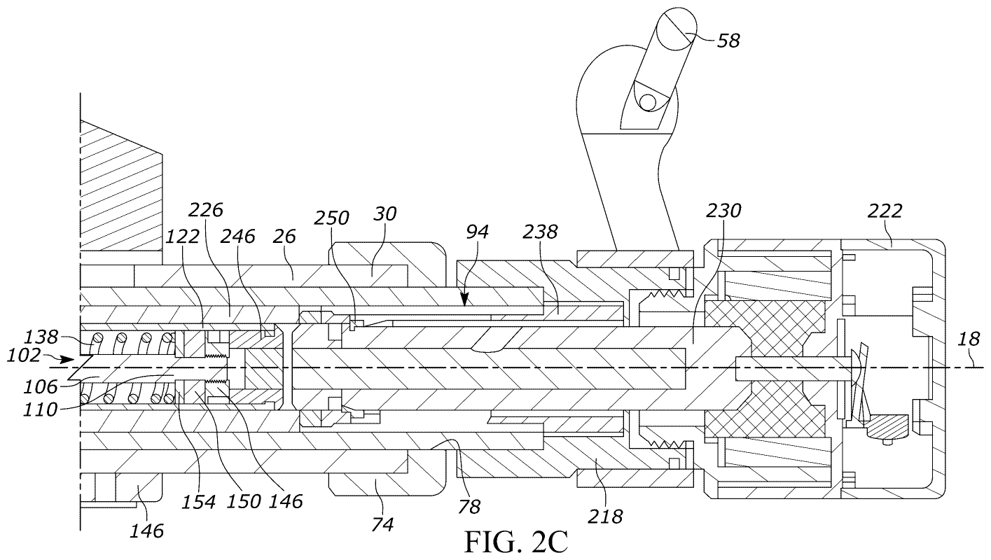

With respect to FIGS. 2-2C, the load break tool 10 is illustrated in a closed position. In the closed configuration, the main body 14 is in the retracted position, such that the lower end of the inner tube 30 is adjacent the lower end of the outer tube 26.

As shown in FIGS. 2 and 2A, the outer tube 26 includes an outer tube base 66 fixed to the bottom of the outer tube 26. An outer tube lower end cap 70 is coupled to the outer tube base 66. An outer tube upper end cap 74 is coupled to the upper end of the outer tube 26 and includes a central opening 78 surrounding and supporting the inner tube 30. An axial slot 86 extending from near the lower end of the outer tube 26 along the length of the outer tube 26 toward the upper end of the outer tube 26. In the illustrated configuration, the axial slot 86 is positioned on the same side as the clip assembly 34 and opposite the release clamp. The inner tube 30 includes a guide projection 90 extending into the axial slot 86. The guide projection 90 prevents rotation of the inner tube 30 with respect to the outer tube 26. The inner tube 30 defines an inner cavity 94.

With reference to FIGS. 2, 2A, and 2B, a spring assembly 102 is mounted within the main body 14. The spring assembly 102 includes a spring guide rod 106. As shown in FIGS. 2 and 2A, the spring guide rod 106 is coupled to the outer tube lower end cap 70 and extends along the tool axis 18 into the inner cavity 94 of the inner tube 30. The spring guide rod 106 is coupled to the outer tube lower end cap 70 by a fastener 118. In the illustrated configuration the spring guide rod 106 includes at least an upper threaded end 110 and a lower threaded end 114. In other configurations, the entire guide rod may be threaded, or the ends may be formed in other ways to allow for engagement by different types of fasteners. The spring guide rod 106 can be coupled to the outer tube lower end cap 70 by a pair of nuts 118 threaded onto the threaded lower end of the spring guide rod 106 on either side of the outer tube lower end cap 70. As shown in FIGS. 2 and 2A, a spring tube 122 is slidably received in the inner cavity 94. The spring tube 122 is a hollow cylindrical tube which is positioned to surround the spring guide rod 106. A spring tube base 126 is coupled to the end of the spring tube 122 to enclose the lower end of the spring tube 122. The spring tube base 126 includes a central bore 130 which slidably received the spring guide rod 106. The spring tube base 126 further includes an end face 134. A compression spring 138 is positioned in the spring tube 122 surrounding the spring guide rod 106. The lower end of the compression spring 138 is braced against the end face 134 of the spring tube base 126. As shown in FIGS. 2 and 2B, the spring assembly 102 further includes a flange nut 146 secured to the upper threaded end 110 of the spring guide rod 106. The flange nut 146 retains a spring bushing 150 on the spring guide rod 106. The spring bushing 150 is slidable in the spring tube 122 and holds the spring guide rod 106 concentric to the spring tube 122. A washer 154 is positioned adjacent the spring bushing 150. The upper end of the compression spring 138 is braced against the washer 154.

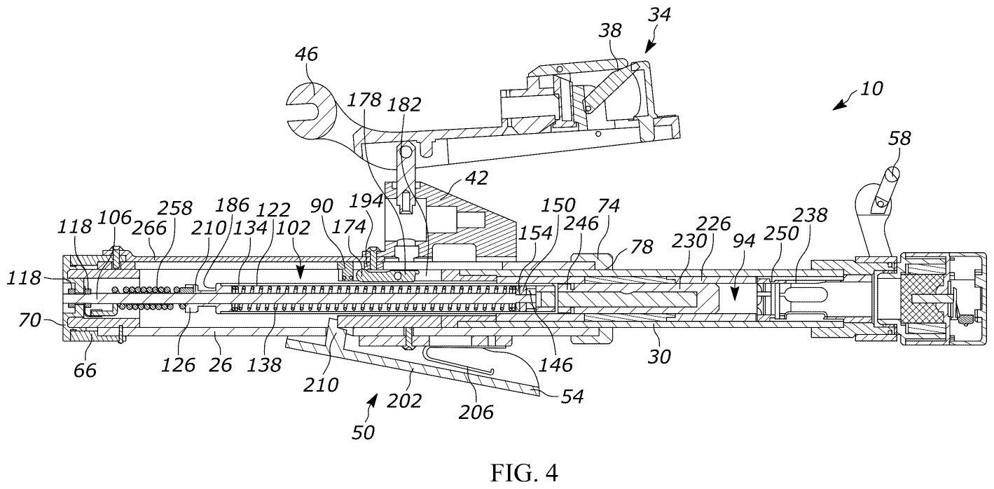

With continued reference to FIGS. 2 and 2A, the spring tube 122 is axially fixed with respect to the inner tube 30 by a trigger assembly 166. The trigger assembly 166 includes a trigger 170 having an actuation end 174 and a locking end 178. The trigger 170 is rotatably mounted to the inner tube 30 adjacent the lower end of the inner tube 30. The trigger assembly 166 is mounted in a side opening 182 in the inner tube 30 and is movable between a closed position, in which the spring tube 122 is axially fixed with respect to the inner tube 30, and an open position, in which the spring tube 122 is permitted to axially displace or slide within the inner tube 30. In the closed position the locking end 178 of the trigger 170 engages a recess 186 formed in the spring tube base 126. The actuation end 174 extends past a side of the inner tube 30 and into the axial slot 86 formed in the outer tube 26. The trigger 170 is biased to the closed position by a biasing member 190. In the illustrated configuration, the biasing member 190 is a double torsion spring 190. In the open position (see FIG. 4), the trigger 170 is pivoted such that the actuation end 174 does not extend into the axial slot 86 and the locking end 178 is moved out of the recess 186 in the spring tube base 126. The trigger 170 is moved to the closed position from the open position by an actuator 194 (FIGS. 2 and 2B) mounted to the outer tube 26. The actuator 194 presses against the actuation end 174 and overcomes the biasing force of the torsion spring 190 to move the actuation end 174 out of the axial slot 86 and the locking end 178 out of the recess 186.

With reference to FIGS. 2 and 2B, the release clamp assembly 50 is mounted adjacent an opening 198 in the outer tube 26. The release paddle 54 is part of a lever 202 that is mounted to the outer tube 26 by a leaf spring 206. The lever 202 also includes a locking projection 210 that is aligned with the opening 198 in the outer tube 26. The leaf spring 206 biases the lever 202 to an engaged position. In the engaged position (see FIG. 4), the locking projection 210 enters through the opening 198 and engages the lower end of the inner tube 30. When the load break tool 10 is in the closed configuration, the locking projection 210 is positioned in the opening 198 in the outer tube 26. When the release paddle 54 is moved to a release position, the locking projection 210 is removed from the opening 198 in the outer tube 26.

With reference to FIGS. 2 and 2C, the inner tube 30 includes an inner tube head 218. The hook loop 58 is mounted to the inner tube head 218. An inner tube end cap 222 is screwed into the inner tube head 218. The inner cavity 94 extends within the inner tube head 218 and the inner tube end cap 222. A liner 226 is positioned in the inner cavity 94 between the spring tube 122 and the inner tube 30. The liner 226 is axially fixed with respect to the inner tube 30. A trailer 230 is coupled to an upper end of the spring tube 122. The trailer 230 is axially fixed with respect to the spring tube 122.

The load break tool 10 is designed to divert a load through the load break tool 10 and then to break the circuit and disperse the resulting arc. Therefore, when the load break tool 10 is in a closed configuration, current is carried through the load break tool 10 from the hook loop 58 to the clip assembly 34. As shown in FIG. 2C, the hook loop 58 is secured to the inner tube head 218. A stationary contact 238 is mounted in the inner cavity 94 below the inner tube head 218 at the upper end of the inner tube 30 and is axially fixed with respect to the inner tube 30. The stationary contact 238 extends into and contacts the inner tube head 218. The trailer 230 is supported by the stationary contact 238.

With continued reference to FIG. 2C, a moving contact 246 is fixed to the lower end of the trailer 230. The stationary contact 238 at least partially surrounds the moving contact 246 and is biased into engagement by a garter spring 250. The moving contact 246 is also fixed to the upper end of the spring tube 122. The moving contact 246 may include a tungsten-copper ring fitted at the end to provide additional strength and prevent arcing.

With reference to FIG. 2A, at the other end of the spring tube 122, a flexible current shunt 258 is fixed to the spring tube base 126. The flexible current shunt 258 is shown as coiled around the spring guide rod 106, but in other configurations can be otherwise arranged. The flexible current shunt 258 includes a ring terminal 262. The ring terminal 262 is fixed to the outer tube lower end cap 70 by the same fasteners 118 used to mount the spring guide rod 106. An outer current shunt 266 is mounted to the outer tube 26 over the axial slot 86. The outer current shunt 266 extends between the outer tube base 66 and the bracket 42 supporting the clip assembly 34.

Therefore, the current path extends from the hook loop 58 to the clip assembly 34. First, current is transferred from the hook loop 58, through the inner tube head 218, to the stationary contact 238. The stationary contact 238 transfers the current through the moving contact 246 to the spring tube 122. The spring tube 122 carries the current to the spring tube base 126 which transfers the current to the flexible current shunt 258. The current is carried through the ring terminal 262 of the flexible current shunt 258 to the outer tube lower end cap 70 and thereby to the outer tube base 66. The outer tube base 66 transfers the current to the outer current shunt 266 which carries the current to the bracket 42 and the clip assembly 34 to complete the circuit.

In operation, the load break tool 10 is fixed to the insulated pole at the universal adapter 46. The insulated pole is used by an operator, such as a lineman, to maneuver the load break tool 10 into position, and specifically into contact with both switch contacts. For example, the hook loop 58 can be connected to arcing horns of a switch. The clip assembly 34 can be connected to a pull ring of the switch. When the hook loop 58 is connected to the arcing horns and the clip assembly 34 has received the pull ring, the operator can use the insulated pole to pull the load break tool 10. The force applied to the universal adapter 46 displaces the outer tube 26 relative to the inner tube 30. This motion moves the load break tool 10 toward a tripping configuration.

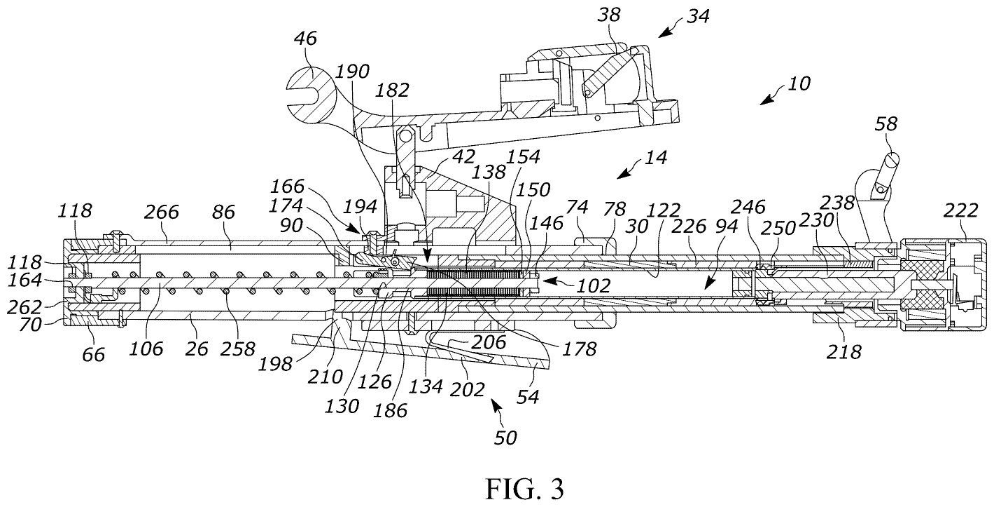

With reference to FIG. 3, the load break tool 10 is illustrated in a tripping configuration. The outer tube 26 has displaced downward, meaning the main body 14 is now in the extended configuration. The movement of the outer tube 26, and the connected outer tube base 66 and outer tube lower end cap 70, has displaced the spring guide rod 106 with respect to the inner tube 30. The trigger 170 is still in the closed position, axially fixing the spring tube 122 to the inner tube 30. The actuation end 174 of the trigger 170 is approaching the actuator 194 mounted to the outer tube 26. The spring tube base 126 has not moved with the spring guide rod 106; therefore, the compression spring 138 has been compressed between the washer 154 and the end face 134 of the spring tube base 126. The release clamp assembly 50 is still in an intermediate position where the locking projection 210 is received in the opening 198 in the outer tube 26. Current is still being conducted through the same path described with respect to the closed position. The flexible current shunt 258 has extended to account for the larger distance between the spring tube base 126 and the outer tube lower end cap 70.

With reference to FIG. 4, as the operator continues to move the insulated pole, the load break tool 10 trips and moves to the open configuration. The further axial displacement of the outer tube 26 with respect to the inner tube 30 moves the actuation end 174 of the trigger 170 into engagement with the actuator 194. The actuation end 174 is thus moved out of the slot 86 and the locking end 178 is moved out of the recess 186 in the spring tube base 126. The spring tube 122 is therefore free to slide with respect to the inner tube 30. Additionally, the displacement of the outer tube 26 with respect to the inner tube 30 moves the inner tube 30 past the opening 198 in the outer tube 26, allowing the locking projection 210 of the release clamp assembly 50 to move further into the outer tube 26 and engage the end of the inner tube 30. This locks the inner tube 30 from axial movement relative to the outer tube 26. The compressed spring exerts force between the spring tube base 126 and the washer 154 of the spring guide rod 106, moving the spring tube 122 relative to the outer tube 26, toward the outer tube lower end cap 70. This movement pulls the trailer 230 through the liner 226. During this motion, the current path is broken when the stationary contact 238 is no longer in contact with either the trailer 230 or the moving contact 246. At this point, the current attempts to form its own path through the air, however, as the trailer 230 moves through the liner 226, a gap is created between the trailer 230 and the liner 226. Any arcs created in this gap are quickly extinguished, and the circuit is broken.

The operator can then disengage the clip assembly 34 from the pull ring, and the hook loop 58 from the arc horns. The load break tool 10 remains in the open configuration until an operator moves the release paddle 54 to the release position, moving the locking projection 210 out from the opening 198 in the outer tube 26, and allowing the inner tube 30 to displace with respect to the outer tube 26 and to retract into the outer tube 26. Movement of the inner tube 30 into the retracted position allows the spring of the trigger assembly 166 to move the locking end 178 of the trigger 170 back into engagement with the recess 186 in the spring tube base 126. The load break tool 10 is then in the closed configuration once again.

Typical load break tools utilize a tension spring to move the trailer 230 through the liner 226. However, load break tools using these configurations have several disadvantages. The proposed design offers several advantages over tools with a standard configuration. First, the described load break tool 10 has an improved ease of manufacture as well as improved ease of repair or disassembly. The described load break tool 10 also removes complications associated with parts freely rotating inside of the assembly. Finally, the described load break tool 10 ensures the spring will be released at the same load repeatedly. This allows for improved wear predictions of the spring. Additionally, the improvements to the design do not affect the operation thereof, meaning the tool is intuitive to use and has increased performance compared to other tools.

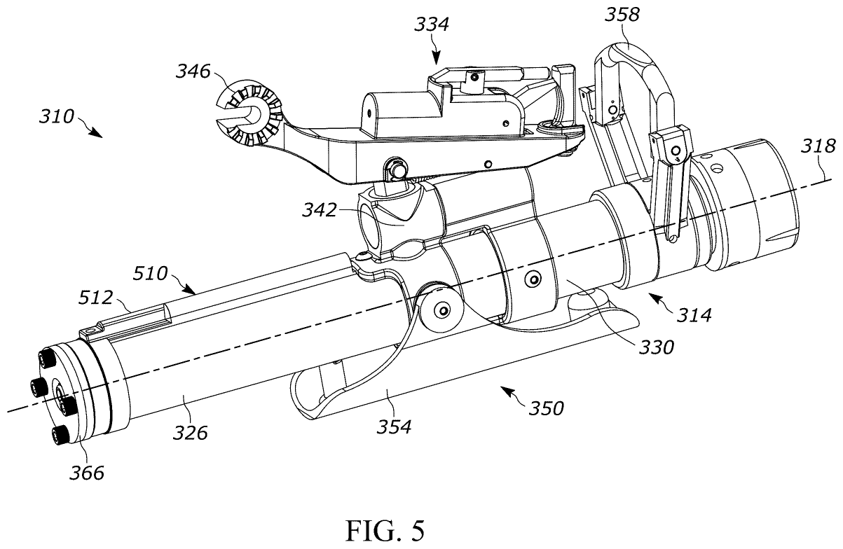

FIG. 5 illustrates an exemplary load break tool 310. The configuration of the load break tool 310 shares a number of similar components with the load break tool 10 shown in FIGS. 1-4. The load break tool 310 includes a main body 314 or a tube assembly extending along a tool axis 318. The main body 314 includes an outer tube 326 formed as a cylindrical pipe extending along the tool axis 318. An inner tube 330, similarly formed as a cylindrical pipe, is slidably received in an upper end of the outer tube 326. The main body 314 is movable between an extended configuration, in which the inner tube 330 extends from the upper end of the outer tube 326, and a retracted configuration, in which the inner tube 330 is mostly received within the outer tube 326.

Further, the load break tool includes a clip assembly 334 mounted on a bracket 342 that also supports a universal adapter 346. A release clamp assembly 350 is mounted to the outer tube 326 opposite the clip assembly 334. The release clamp assembly 350 includes a release paddle 354 mounted to the outer tube 326 for movement between a locked position and a release position. The load break tool 310 further includes a hook loop 358 coupled to the upper end of the inner tube 330. The hook loop 358 is configured to engage a second contact of the switch.

In certain configurations, the load break tool 310 includes an indicator housing 510 connected to outer tube 326. The indicator housing 510 can extend from the outer tube base 366 toward the bracket 342 along the exterior of the outer tube 326. The indicator housing 510 can extend outwardly from the outer tube 326 and have a window portion 512. The window portion 512 allows a user to view at least a portion of a trigger assembly 466. For example, an indicator 514 of the trigger 470 can be viewable through the window 512. Being able to view the orientation of the trigger 470 can allow a user to confirm that the load break tool 310 is reset in the closed configuration before starting a load break operation.

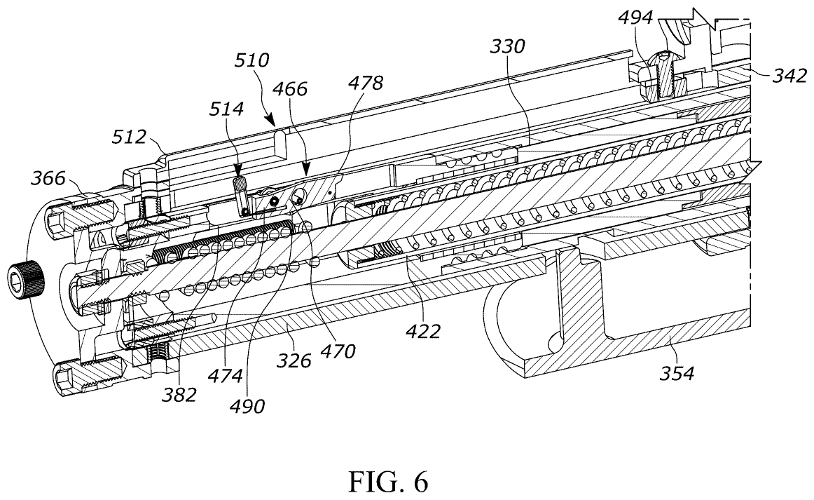

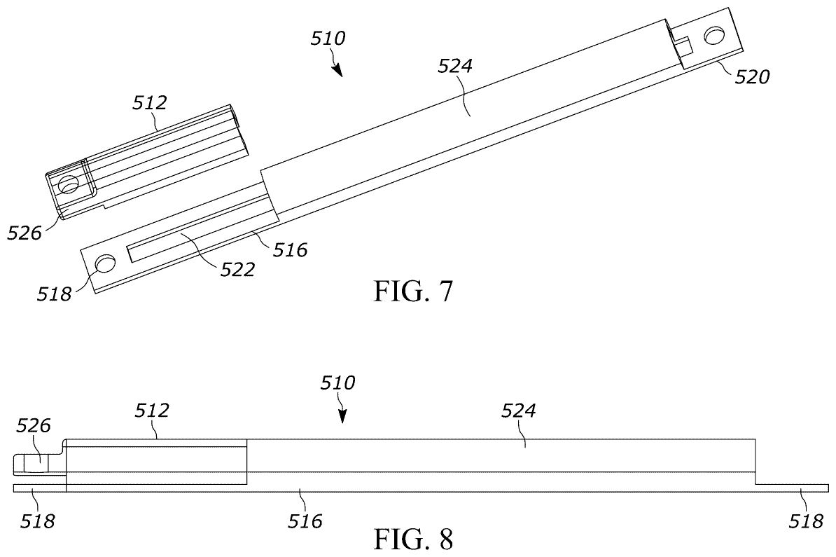

As best shown in FIGS. 7 and 8, the indicator housing 510 can include a base 516 extending between a first tab 518 and a second tab 520. The first and second tabs 518, 520 can include openings configured to receive a fastener to secure the indicator housing 510 to the outer tube 326. For example, as shown in FIG. 6, the first tab 518 can receive a fastener that extends through the tube base 366 and the outer tube 326. The second tab 520 can receive a fastener that extends through the bracket 342 and into the actuator 494. The base includes an interior slot 522 to permit passage of at least a portion of the trigger assembly 466 into the indicator housing 510.

A shroud 524 extends from the base 516 in between the first tab 518 and the second tab 520. The base 516 and the shroud 524 can be integrally formed or be formed for separate pieces that are connected, for example by a fastener or joining process such as welding. The shroud 524 can have an arcuate outer surface covering the interior slot 522 and permitting space for at least a portion of the trigger assembly 466 to travel in the indicator housing 510. For example, the indicator 514 can move through the shroud 524 as the inner tube 330 moves with respect to the outer tube 326. The shroud 524 can be spaced from the first tab 518, exposing a portion of the base 516 and the slot 522. This spacing provides an exposed range of travel of the indicator 514. Different configurations, including other rectilinear or curvilinear shapes for the shroud 524 can be used.

In certain configurations, the window 512 is connected to the base 516 to cover the trigger 470 in the exposed portion. The window 512 can be made from a substantially transparent material that provides visibility to the interior of the indicator housing and can be an impact resistant material such as polycarbonate. The window 512 can have an outer profile that substantially matches the outer profile of the shroud 524. For example, the window 512 can have an arcuate outer profile. The window 512 can include a tab 526 that extends over the first tab 518 of the base 516. The window tab 526 can include an opening for receiving a fastener that substantially aligns with the opening on the base first tab 518. When connected to the base 516, the window tab 526 can be spaced from the base first tab 518.

In certain implementations, at least a portion of the indicator housing 510 acts as a current shunt between the outer tube base 366 and the bracket 342. For example, the base 516 and the shroud 524 can be made from a conductive material.

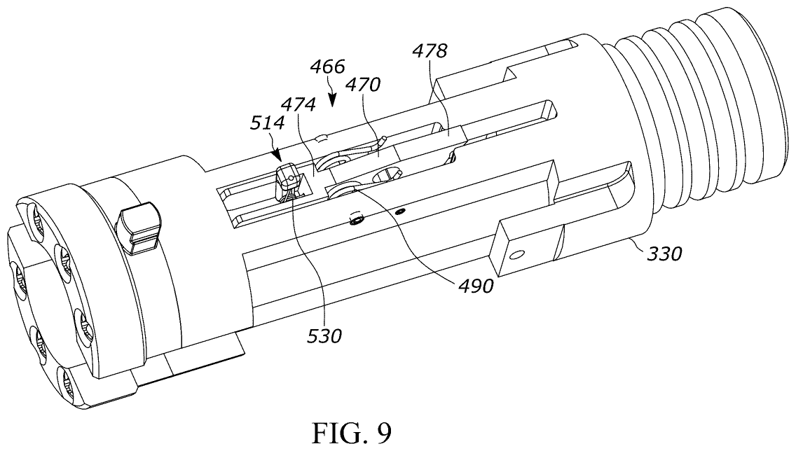

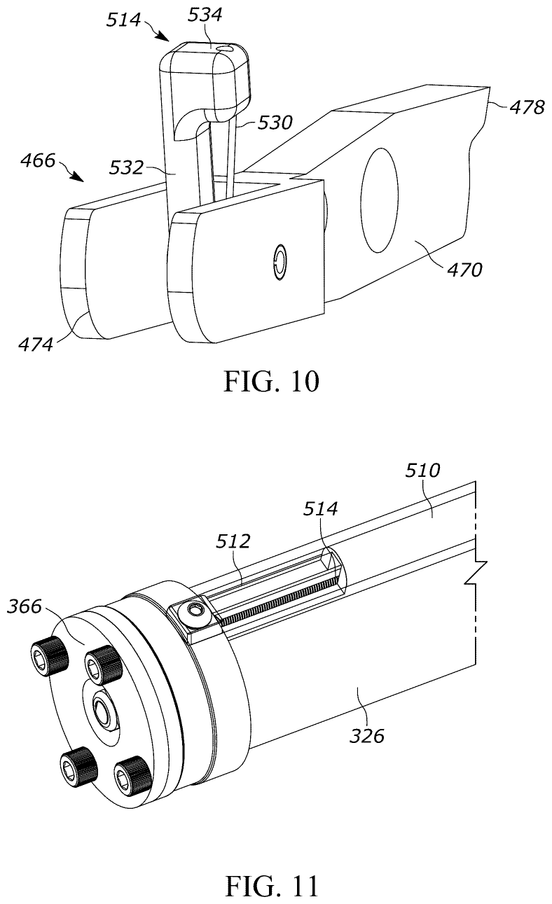

FIG. 9 shows a portion of the inner tube 330 and the trigger assembly 466 and FIG. 10 shows an isolated view of the trigger assembly 466. In certain configurations, the trigger assembly 466 includes a trigger 470 having an actuation end 474 and a locking end 478. In certain configurations, the indicator 514 is moveably connected to the actuation end 474 of the trigger 470. The actuation end 474 can have a yoke configuration with the indicator rotatably connected between the arms of the yoke. The indicator 514 can be rotatable about a pin and biased into a first position by a biasing member 530. In certain configurations the biasing member 530 includes a torsion spring having a first end positioned in the trigger 470 and a second end extending through an aperture in the indicator. Other configurations for these components and other types of biasing members can also be used.

In certain configurations the indicator 514 includes a shaft 532 pivotally connected to the actuation end 474. A protrusion 534 can extend from the shaft 532, giving the indicator 514 a substantially P-shaped configuration. The second end of the biasing member 530 can extend into the protrusion 534. The indicator 514 can be a different color than other components of the load break tool 310 so that visibility is increased. Other configurations of the indicator 514 can be used.

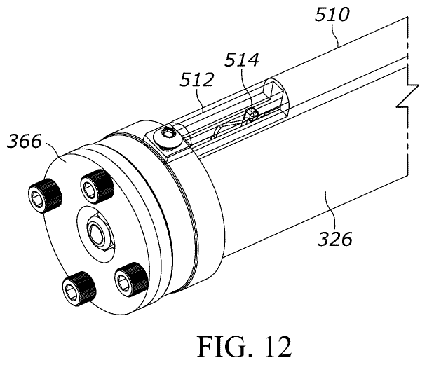

The trigger 470 is rotatably mounted to the inner tube 330 adjacent the lower end of the inner tube 330. The trigger assembly 466 is mounted in a side opening 382 in the inner tube 330 and is movable between a closed position, in which the spring tube 422 (shown in FIG. 6) is axially fixed with respect to the inner tube 330, and an open position, in which the spring tube 422 is permitted to axially displace or slide within the inner tube 330. In the closed position the locking end 478 of the trigger 470 engages a portion of the spring tube 422. The indicator 514 extends past a side of the inner tube 330 and into the indicator housing 510 so that the indicator is visible through the window (as shown in FIG. 12).

The trigger 470 is biased to the closed position by a biasing member 490. In the illustrated configuration, the biasing member 490 is a double torsion spring. In the open position, the trigger 470 is pivoted such that the indicator 514 does not extend into the indicator housing 510 (as shown in FIG. 6) and the locking end 478 is moved out of engagement with the spring tube 422. The trigger 470 is moved to the closed position from the open position by an actuator 494 mounted to the outer tube 326. The actuator 494 presses against the indicator and overcomes the biasing force of the indicator biasing mechanism and the trigger biasing mechanism 490 to move the locking end 478 out of engagement with the spring tube 422. In the open configuration, the indicator 514 is positioned in the indicator housing 510, covered by the shroud 512 (as shown in FIG. 11)

The load break tool 10 remains in the open configuration until an operator moves the release paddle 354 to the release position, allowing the inner tube 330 to displace with respect to the outer tube 326 and to retract into the outer tube 326. Movement of the inner tube 330 into the retracted position allows the spring of the trigger assembly 466 to move the locking end 478 of the trigger 470 back into engagement with the spring tube 422. The load break tool 310 is then in the closed configuration once again. In certain instances the inner tube 330 can be moved into a retracted position but is not fully in the closed position. In such instances, it can be difficult for a user to be certain that the tool 310 is fully seated and closed. The indicator 514 provides a visual confirmation to a user to determine that the tool 310 is fully closed and can be safely used for a new operation (as shown in FIG. 12).

The foregoing detailed description of the certain exemplary configurations has been provided for the purpose of explaining the general principles and practical application, thereby enabling others skilled in the art to understand the disclosure for various configurations and with various modifications as are suited to the particular use contemplated. This description is not necessarily intended to be exhaustive or to limit the disclosure to the exemplary configuration disclosed. Any of the configuration and/or elements disclosed herein may be combined with one another to form various additional configurations not specifically disclosed. Accordingly, additional configuration are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary configuration of the present disclosure, and are not intended to limit the structure of the exemplary configuration of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described configurations. Unless specified or limited otherwise, the terms “mounted,” “connected,” “supported,” and “coupled” and variations thereof are used broadly and encompass both direct and indirect mountings, connections, supports, and couplings.

What is claimed:

1. A load break tool comprising:
a main body extending along a longitudinal axis between a first end and a second end, the main body being movable between an extended configuration and a retracted configuration, the main body including an indicator housing having a window;
a trigger assembly positioned in the main body, the trigger assembly moveable between a first position in the retracted configuration and a second position in the extended configuration, the trigger assembly including an indicator viewable by a user through the window when the main body is in the retracted position;
a first contact coupled to the first end and configured to selectively couple with a first switch contact;
a second contact coupled to the second end and configured to selectively couple with a second switch contact, wherein in the retracted configuration the first contact is in electrical communication with the second contact.

2. The load break tool of claim 1, wherein the main body includes an outer tube and an inner tube slidably received in the outer tube, and wherein the outer tube includes an axial slot and the inner tube includes a guide projection configured to travel within the axial slot, preventing rotation of the inner tube with respect to the outer tube.

3. The load break tool of claim 2, wherein the inner tube is connected to the outer tube by at least one tension spring, and wherein the tension spring biases the main body to the retracted configuration.

4. The load break tool of claim 1, wherein the main body includes an outer tube with the first contact, an inner tube slidably received in the outer tube and having the second contact, and a spring tube slidably received in the inner tube.

5. The load break tool of claim 1, wherein the trigger assembly includes a trigger and the indicator is pivotally connected to the trigger.

6. The load break tool of claim 5, wherein a biasing mechanism biases the indicator relative to the trigger.

7. The load break tool of claim 5, wherein the trigger includes a yoke and the indicator is positioned between arms of the yoke.

8. The load break tool of claim 1, wherein the indicator housing includes a shroud extending from the window.

9. The load break tool of claim 8, wherein the indicator is positioned inside of the shroud in the extended position.

10. A load break tool comprising:
an outer tube extending along a longitudinal axis and defining a first cavity, the outer tube including an outer tube end cap;
an indicator housing extending from the outer tube, the indicator housing including a window;
an inner tube at least partially received inside the first cavity and defining a second cavity, the inner tube being movable with respect to the outer tube along the longitudinal axis between a retracted position and an extended position;
a trigger assembly connected to the inner tube, the trigger assembly including an indicator viewable by a user through the window when the inner tube is in the retracted position;
a guide rod fixed to the outer tube and extending into the second cavity, the guide rod including a first surface;
a spring tube coaxially mounted around the guide rod and selectively axially coupled to the inner tube by the trigger assembly, the spring tube including a second surface; and
a compression spring mounted between the first surface and the second surface, wherein when the spring tube is coupled to the inner tube by the trigger assembly, the compression spring biases the inner tube toward the retracted position.

11. The load break tool of claim 10, wherein when the spring tube is uncoupled from the inner tube by the trigger assembly, the compression spring biases the spring tube toward the outer tube end cap along the longitudinal axis.

12. The load break tool of claim 10, wherein the guide rod includes a nut and a washer coupled to an end of the guide rod distal from the outer tube end cap and wherein the washer forms the first surface.

13. The load break tool of claim 10, wherein the spring tube includes a spring tube base and the spring tube base forms the second surface.

14. The load break tool of claim 13, wherein the spring tube base includes a recess which is engaged by the trigger assembly to couple the spring tube to the inner tube.

15. The load break tool of claim 14, wherein the trigger assembly includes a trigger mounted on the inner tube and biased into engagement with the recess, and an actuator mounted on the outer tube and positioned to engage the trigger when the inner tube moves toward the extended position.

16. The load break tool of claim 10, wherein the inner tube is held in the extended position by a release clamp assembly mounted to the outer tube and including a locking projection that engages a lower end of the inner tube.

17. The load break tool of claim 10, wherein the trigger assembly is movable between an open state, allowing the spring tube to move with respect to the inner tube, and a closed state, axially fixing the spring tube to the inner tube, and wherein the trigger assembly is moved to the open state when the inner tube reaches the extended position.

18. The load break tool of claim 10, wherein the trigger assembly includes a trigger and the indicator is pivotally connected to the trigger.

19. The load break tool of claim 18, wherein a biasing mechanism biases the indicator relative to the trigger.

20. The load break tool of claim 18, wherein the trigger includes a yoke and the indicator is positioned between arms of the yoke.
